(19) United States
(12) Patent Application Publication
(10) Pub. No.: US 2009/0283048 A1
(43) Pub. Date: Nov. 19, 2009

(54) Scoop feeder

(75) Inventor: Derek James Black, York (GB)

Correspondence Address: BROOKS KUSHMAN P.C., 1000 TOWN CENTER, TWENTY-SECOND FLOOR, SOUTHFIELD, MI, 48075, US

(73) Assignee: CRANSWICK PET AND AQUATICS PLC, Kingston Upon Hull (GB)

(21) Appl. No.: 12/122,057

(22) Filed: May 16, 2008

(51) Int. Cl. A01K 7/06

(52) U.S. Cl. 119/74

(57) ABSTRACT

A scoop or bird feeder (1; 12) comprising a frame (3, 4, 5; 16, 17, 18) having a hanger (45; 20) which is adapted in use to suspend the bird feeder (1; 12) from a convenient place, and a feed hopper (2; 13) which is removably received in the frame (3, 4, 5; 16, 17, 18) and which has a number of openings in the side thereof through which birds can feed on bird food contained within the feed hopper (2; 13). The feed hopper (2; 13) may conveniently comprise a handle (9; 15) such that it can be used in the manner of a scoop for filling same.

### BACKGROUND OF THE INVENTION

1. Field of the Invention

The present invention relates to a scoop feeder for birds.

2. Background Art

Conventional bird feeders generally comprise a tubular body which is closed at the bottom and open at the top to allow bird feed to be held therein. The tubular body is usually made either of an open wire mesh, for use with bird foods consisting of large particles, such as peanuts and sunflowers, or of a rigid plastics material with a number of feeding ports located in the side, for use with bird foods consisting of small particles, such as millet seed or sunflower kernels.

The bird feeder is usually provided with a hanger from which it can be suspended on a hook, a bracket or a branch in a convenient place for birds to feed and be viewed. When the bird feeder is empty it must either be filled in situ by pouring bird food in through the open top or taken down so that this task can be performed. Filling the bird feeder in situ is difficult to carry out without spilling bird feed. Taking the bird feeder down is often difficult because the most suitable place for hanging the bird feeder is often not easily reached.

### SUMMARY OF THE INVENTION

It is an object of the present invention to provide a bird feeder which is easy to fill.

It is yet another object of the present invention to provide a bird feeder which can be easily taken down to be refilled.

According to the present invention there is provided a bird feeder comprising a frame having a hanger which is adapted in use to suspend the bird feeder from a convenient place, and a feed hopper which is removably received in the frame and which has a number of openings in the side thereof through which birds can feed on bird food contained within the feed hopper.

Conveniently, the frame comprises a top, a bottom and connecting members connecting the top to the bottom to define an internal space there between and an opening in the side thereof through which the feed hopper can be inserted into and removed from the internal space, and further comprises means for locating the feed hopper in the frame.

In one embodiment of the present invention the bottom of the opening is defined by a raised lip extending upwardly from the bottom of the hanging frame and the removable feed hopper is retained in place within the hanging frame behind the raised lip. In use, the removable feed hopper is removed from the hanging frame by lifting the bottom above the raised lip and pulling the removable feed hopper forward through the opening. The removable feed hopper is returned to the hanging frame by reversing these steps.

In another embodiment of the present invention a recess is provided in the bottom of the hanging frame which is suitably shaped to accommodate the bottom of the removable feed hopper. The removable feed hopper is located in the hanging frame by inserting it between the top and bottom of the hanging frame and then locating the base of the removable feed hopper into the recess. Conveniently, the depth of the recess is approximately 5 mm. Preferably, a roller ball is provided on the underside of the bottom of the removable feed hopper. The roller ball rolls over the bottom of the hanging frame as the removable feed hopper is removed from or returned to the hanging frame. Conveniently, a hole is provided in the bottom of the recess to accommodate the roller ball and stabilise the removable feed hopper in the hanging frame.

In yet another embodiment of the present invention a grooved track is provided in the bottom of the hanging frame which grooved track accommodates a wheel on the bottom of the removable feed hopper. In use, the wheel is located in the grooved track and the removable feed hopper is slid into and out of the internal space defined by the hanging frame. Preferably, the depth of the grooved track is approximately 5 mm.

Conveniently, the removable feed hopper is provided with a handle. The handle allows the removable feed hopper to be lifted into and out of the hanging frame. It also makes it easy to fill in that the removable feed hopper can be used after the fashion of a scoop to scoop up bird food contained within a bag or bin.

### BRIEF DESCRIPTION OF THE DRAWINGS

Embodiments of the present invention will now be described, by way of example, with reference to the accompanying drawings, in which:

FIG. 1 shows a schematic view of a bird feeder according to the present invention;

FIG. 2 shows the bird feeder of FIG. 1 with the removable feed hopper removed from the hanging frame to be re-filled with bird food;

FIG. 3 illustrates how the removable feed hopper is removed from the hanging frame;

FIGS. 4a and b show an embodiment of a bird feeder according to the present invention, in which FIG. 4a is a view of the hanging frame and FIG. 4b is a view of the removable feed hopper;

FIG. 5 is a detail of the bottom of the removable feed hopper shown in FIG. 4b;

FIGS. 6a and 6b show another embodiment of a bird feeder according to the present invention, in which FIG. 6a is a view of the hanging frame and FIG. 6b is a view of the removable feed hopper; and,

FIG. 7 is a detail of the bottom of the removable feed hopper shown in FIG. 6b.

### DETAILED DESCRIPTION OF THE PREFERRED EMBODIMENT(S)

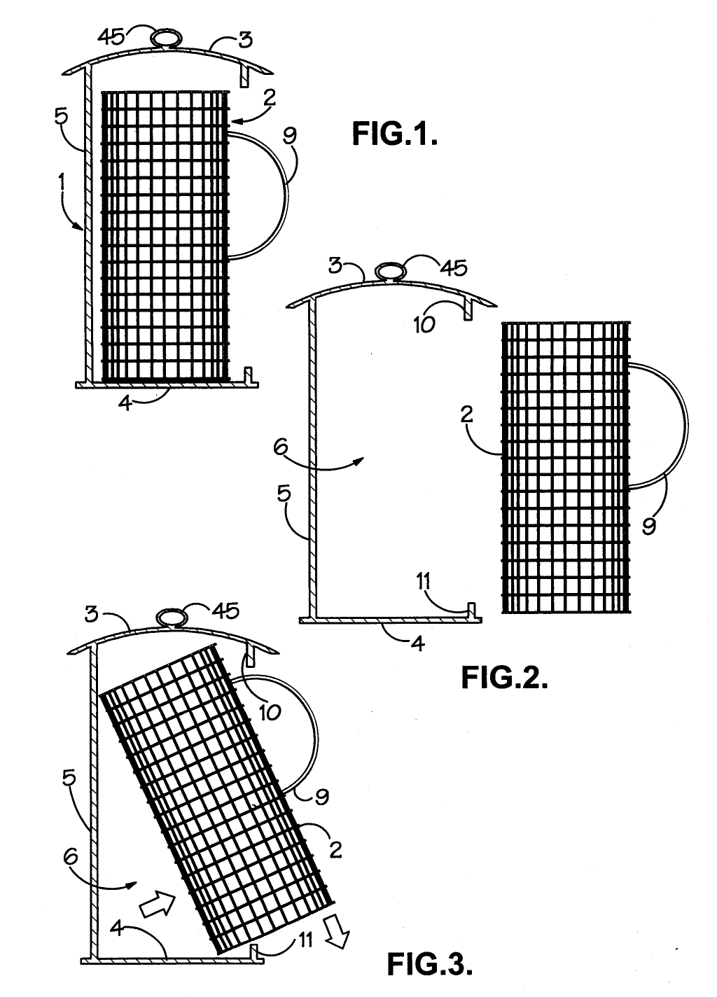

Referring to FIGS. 1, 2 and 3 of the drawings the bird feeder comprises a frame 1 and a removable food hopper 2. The removable feed hopper 2 is essentially comprised of open wire mesh formed into a tube which is closed at the bottom and open at the top. A handle 9 is provided on the side of the wire mesh tube. The wire mesh feed hopper 2 is suitable for use with large particle bird foods, such as peanuts and sunflower seeds. In an alternative embodiment of the present invention the removable feed hopper may be comprised of a tube of plastics material which is closed at the bottom and open at the top with a number of feeding ports in the side thereof for use with small particle bird foods, such as millet seed and sunflower kernels.

The frame 1 comprises a top 3, a bottom 4 and connecting members 5 (only one of which is visible) connecting the top 3 to the bottom 4. A ring 45 is provided on the top 3 to allow the frame to be suspended in a convenient place for birds to feed. Between them, the top 3, the bottom 4 and the connecting members 5 define an internal space 6 having an opening 7 on one side thereof through which the feed hopper 2 can be inserted into and removed from the internal space 6. The upper edge of the opening 7 is defined by a lip 10 extending downwardly from the top 3 and the bottom edge of the opening 7 is defined by a lip 11 extending upwardly from the bottom 4. Together the upper and lower lips 10 and 11 serve to retain the removable feed hopper 2 within the internal space 6 defined by the frame 1.

When the removable feed hopper 2 requires filling it is removed from the frame 1 by lifting it up within the frame 1 and pulling the bottom of it forwardly over the upper edge of the bottom lip 11, as shown in FIG. 3. Once the bottom of the removable feed hopper 2 is clear of the bottom lip 11 the removable feed hopper 2 is then drawn downwardly away from the top lip 10 until it is clear of the frame 1. With the removable feed hopper 2 removed from the hanger 1 it can now be filled with bird food. This is conveniently achieved by scooping bird food into the removable feed hopper 2 using the handle 9. The removable feed hopper 2 is returned to the frame 1 by reversing these steps.

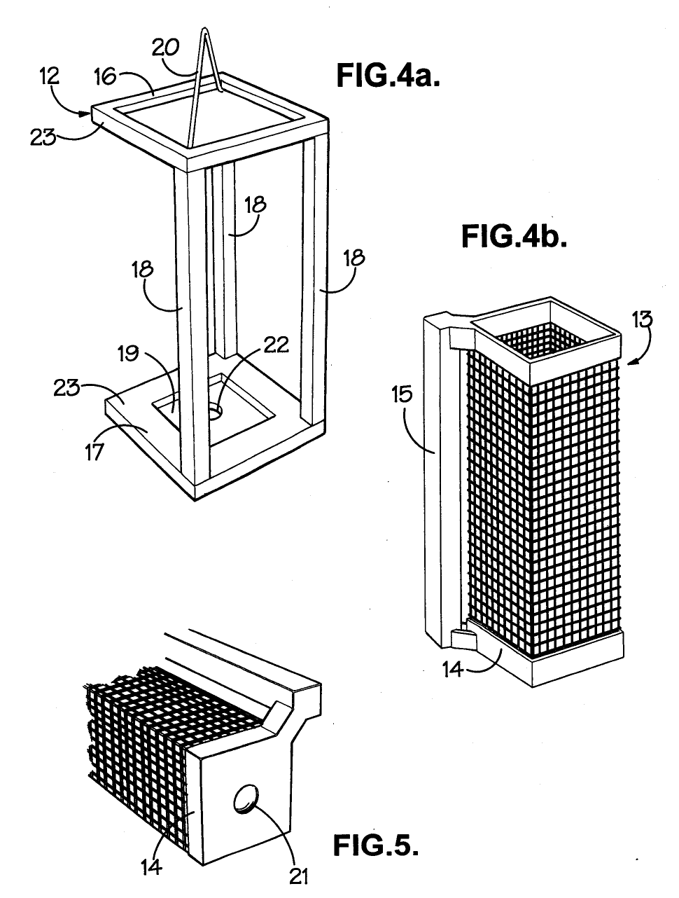

Referring now to FIGS. 4a and 4b there is shown another embodiment of a bird feeder according to the present invention comprising a frame 12 and a feed hopper 13 which is adapted to be removably received within the frame 12. The removable feed hopper 13 is comprised of open wire mesh formed into a tube of square section. The bottom of the tube is closed by a base 14 and the top is open. A handle 15 is connected to the top and to the bottom of the square tube.

The frame 12 essentially comprises a square top 16, a square bottom 17 and three connecting members 18 connecting the top 16 to the bottom 17 at each of three corners. A wire loop 20 is connected to the top and this serves to allow the bird feeder to be suspended from a suitable support. The forth corner 23 is open to receive the removable feed hopper 13. For principally aesthetic purposes, when the removable feed hopper 13 is received in the frame 12 the handle 15 lies between the top 16 and the bottom 17 at the forth corner 23, thus matching the connecting members 18 at each of the other corners.

A square recess 19 of approximately 5 mm in depth and of substantially the same dimensions as the base 14 of the removable feed hopper 13 is provided in the bottom 17 and this serves to locate and retain the removable feed hopper 13 within the frame 12. As shown in FIG. 5 a roller ball 21 is provided on the underside of the base 14 of the removable feed hopper 13 and this rolls over the bottom 17 of the frame 12 as the removable feed hopper 13 is removed from or returned to the space defined inside the frame 12. A hole 22 is provided in the bottom of the recess 19 to accommodate the roller ball 21 and to stabilise the removable feed hopper 13 within the frame 12.

The removable feed hopper 12 is located within the frame 12 by sliding it in between the top 16 and the bottom 17 on the roller ball 21 and then dropping it into place in the recess 18. It is removed simply by reversing these steps.

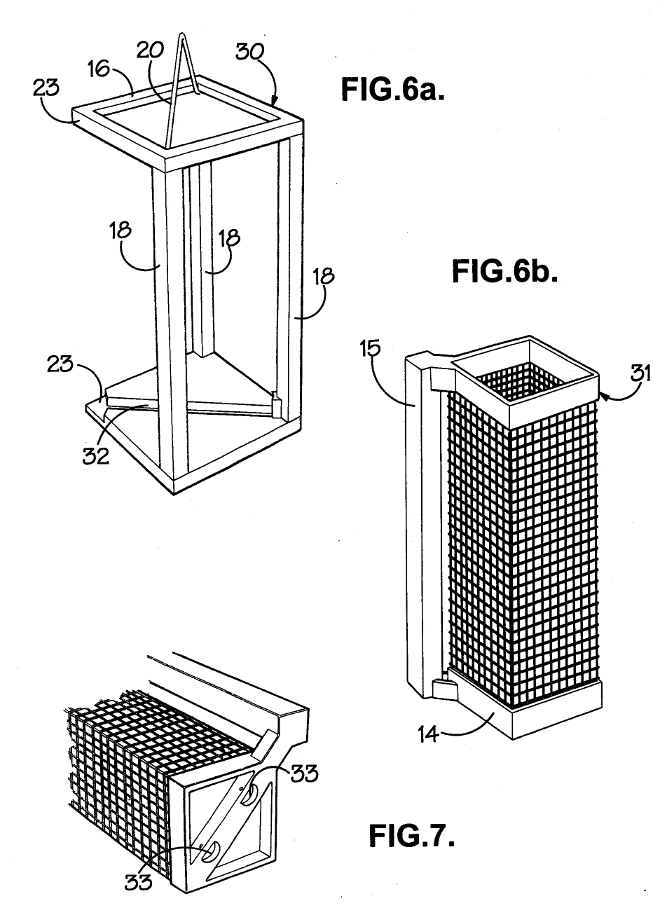

Referring now to FIGS. 6a and 6c there is shown yet another embodiment of a bird feeder according to the present invention comprising a frame 30 and a feed hopper 31 which is adapted to be removably received within the frame 30. Those features of the bird feeder shown in FIGS. 6a and 6b which are also shared with the bird feeder described with reference to FIGS. 4a and 4b have been given like reference numerals.

A grooved track 32 is provided in the bottom 17 of the frame 30. This grooved track 32 accommodates a pair of wheels 33, shown in FIG. 7, on the bottom of the removable feed hopper 31. In use, the wheels 33 are located in the grooved track 32 and the removable feed hopper 31 is slid into and out of the internal space defined by the frame 30. The depth of the grooved track 32 is approximately 5 mm.

The bird feeder according to the present invention is located for birds to feed from it by hanging the hanging frame from a suitable support. To fill the bird feeder the removable feed hopper is removed from the hanging frame, filled with bird feed and then returned to the hanging frame. The design of the hanging frame makes it particularly easy to withdraw and return the removable feed hopper to the hanging frame.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Image Page 1

1-20. (canceled)

21. A bird feeder comprising a frame having a hanger which is adapted in use to suspend the bird feeder from a convenient place, and a feed hopper which is removably received in the frame, the hopper having a handle and a number of openings in the side of the hopper through which birds can feed on bird food contained within the feed hopper.

22. A bird feeder as claimed in claim 21, wherein the frame comprises a top, a bottom and connecting members connecting the top to the bottom to define an internal space there between and an opening in the side thereof through which the feed hopper can be inserted into and removed from the internal space.

23. A bird feeder as claimed in claim 21, further comprising means for locating the feed hopper in the frame.

24. A bird feeder as claimed in claim 23, wherein the means for locating comprises the bottom of the opening being defined by a raised lip extending upwardly from the bottom of the frame for retaining the bottom of the removable feed hopper therebehind.

25. A bird feeder as claimed in claim 23, wherein the means for locating comprises the top of the opening being defined by a lip extending downwardly from the top of the frame for retaining the top of the removable feed hopper therebehind.

26. A bird feeder as claimed in claim 21, the frame comprises a top, a bottom and connecting members connecting the top to the bottom to define an internal space there between and an opening in the side thereof through which the feed hopper can be inserted into and removed from the internal space, wherein the bottom comprises a recess which is suitably shaped to accommodate the bottom of the removable feed hopper.

27. A bird feeder as claimed in claim 26, wherein the removable feed hopper is locatable in the hanging frame by inserting it between the top and bottom of the hanging frame and by locating the base of the removable feed hopper into the recess.

28. A bird feeder as claimed in claim 26, wherein the depth of the recess is approximately 5 mm.

29. A bird feeder comprising a frame having a hanger which is adapted in use to suspend the bird feeder from a convenient place, and a feed hopper which is removably received in the frame, the hopper having a handle and a number of openings in the side of the hopper through which birds can feed on bird food contained within the feed hopper; and a roller ball associated with the underside of the removable feed hopper.

30. A bird feeder as claimed in claim 29, further comprising a hole in the bottom of the recess to accommodate the roller ball and/or to stabilize the removable feed hopper in the hanging frame.

31. A bird feeder comprising a frame having a hanger which is adapted in use to suspend the bird feeder from a convenient place, and a feed hopper which is removably received in the frame, the hopper having a handle and a number of openings in the side of the hopper through which birds can feed on bird food contained within the feed hopper; and a grooved track provided in the bottom of the frame.

32. A bird feeder as claimed in claim 31, wherein the depth of the grooved track is approximately 5 mm.

33. A bird feeder as claimed in claim 31, wherein the removable feed hopper comprises a wheel on its underside locatable in the grooved track.

34. A bird feeder as claimed in claim 33, wherein the removable feed hopper comprises a pair of wheels on its underside locatable in the grooved track.

35. A bird feeder as claimed in claim 21, wherein the handle extends from a side of the removable feed hopper.

36. A bird feeder as claimed in claim 21, wherein the removable feed hopper comprises of a tube which is closed.

37. A bird feeder as claimed in claim 21, wherein the removable feed hopper comprises an open mesh formed into a tube which is closed at the bottom and open at the top.

38. A bird feeder as claimed in claim 36, wherein the tube is of square section.

39. A bird feeder as claimed in claim 38, wherein the frame comprises a square top, a square bottom and three connecting members connecting the top to the bottom at each of three corners, the fourth corner being open to receive the removable feed hopper.

40. A bird feeder claimed in claim 39, wherein the handle is located on a corner of the removable feed hopper.
